(19) United States
(12) Patent Application Publication
(10) Pub. No.: US 2017/0333157 A1
(43) Pub. Date: Nov. 23, 2017

(54) REVERSIBLE CEMENT

(71) Applicants: Gopi Soundararajan, Santa Clara, CA (US); Mohammad Reza Mehrabi, Tujunga, CA (US); Matteo R. Bosisio, Lugano (CH)

(72) Inventors: Gopi Soundararajan, Santa Clara, CA (US); Mohammad Reza Mehrabi, Tujunga, CA (US); Matteo R. Bosisio, Lugano (CH)

(21) Appl. No.: 15/599,762

(22) Filed: May 19, 2017

Related U.S. Application Data
(60) Provisional application No. 62/339,208, filed on May 20, 2016.

(51) Int. Cl. A61C 3/16; A61C 3/03; A61C 1/07; B06B 1/02; A61C 1/06

(52) U.S. Cl. CPC A61C 3/166; B06B 1/0215; B06B 1/02; A61C 1/06; A61C 1/07; A61C 3/03

(57) ABSTRACT

Apparatus and methods for removing a dental crown from a tooth. Chemical bonds within an adhesive, between the adhesive and the crown, and between the adhesive and the tooth may secure the crown to the tooth. The chemical bonds may be weakened. After weakening the bonds, the crown may not be securely affixed to the tooth. After weakening the bonds, the crown may be easily removed from the tooth. The bonds may be weakened by applying ultrasonic waves to the adhesive. Sonic energy of the waves may heat the adhesive. The bonds may be weakened by positioning the adhesive within an electric field. The bonds may be weakened by applying heat to the adhesive. The heating may cause particles within the adhesive to expand. The electric field and/or the sonic energy may be applied via an electronic tool.

### CROSS-REFERENCE TO RELATED APPLICATIONS

This application claims the benefit of U.S. Provisional Application No. 62/339,208, filed on May 20, 2016, which is hereby incorporated by reference herein in its entirety.

### FIELD OF TECHNOLOGY

This disclosure relates to attachment of dental crowns to teeth and removal of dental crowns from teeth. More specifically, the disclosure relates to removing a dental crown securely affixed to a tooth while minimizing risk of damage to the tooth and surrounding tissue.

### BACKGROUND

Enamel of a tooth may become decayed to the point that a significant amount of the enamel must be removed to protect the tooth from complete loss or further decay. The removal of the significant amount of enamel may alter an outer surface (e.g., the “biting” surface) of the tooth. For example, remaining enamel may be shaped like a “stub.”

To allow a patient to continue to use his/her tooth as before, a practitioner may affix a dental crown (hereinafter alternatively, “crown”) to the patient's tooth. The crown may be shaped to resemble the biting surface. The crown may be affixed to the enamel stub. For example, the crown may be affixed to the stub using an adhesive. The adhesive can include a cement or a curable polymer.

Generally, it is preferable to securely affix the crown to the tooth. The crown should protect the underlying tooth. The crown comes into direct contact with food chewed by the patient and is subject to a variety of forces. A method of affixing the crown to the tooth should preferably securely maintain the crown on the tooth despite being subjected to the variety of forces.

In certain instances, it may be necessary to remove a crown. For example, a practitioner may suspect that the enamel underneath the crown has developed caries. As a further example, the crown may fail, such as by fracturing. Because the crown has been securely affixed to the tooth, it may be difficult to remove the crown. It may be difficult to remove the crown without damaging the underlying tooth.

Therefore, it would be desirable to provide apparatus and methods for securely affixing a crown to a tooth. It would further be desirable to provide apparatus and methods for removing a crown securely affixed to the tooth without damaging the tooth. Therefore, it would be desirable to provide apparatus and methods for reversibly cementing (affixing) a crown to a tooth.

### BRIEF DESCRIPTION OF FIGURES

The objects and advantages of the invention will be apparent upon consideration of the following detailed description, taken in conjunction with the accompanying drawings, in which like reference characters refer to like parts throughout, and in which:

FIG. 1 is an exploded perspective view of apparatus in accordance with the principles of the invention;

FIG. 2 is a partial cross-sectional view of apparatus in accordance with the principles of the invention;

FIG. 3 is an expanded view of features of the apparatus shown in FIG. 2 (in a region labeled 3 in FIG. 2);

FIG. 4 is a perspective lateral view of apparatus in accordance with the principles of the invention, with some internal features represented in cross-section;

FIG. 5 is a cross-sectional view of apparatus in accordance with the principles of the invention;

FIG. 6 is a cross-sectional view of apparatus in accordance with the principles of the invention, with some features indicated in phantom;

FIG. 7 is an exploded perspective view of apparatus in accordance with the principles of the invention;

FIG. 8 is an exploded perspective view of the apparatus shown in FIG. 7 in an operational state different from that shown in FIG.7;

FIG. 9 is a perspective view of apparatus in accordance with the principles of the invention, with some features indicated in phantom;

FIG. 10 is an exploded perspective view of the apparatus shown in FIG. 9, with some features indicated in phantom; and

FIG. 11 is a perspective view of apparatus in accordance with the principles of the invention, with some features indicated in phantom, with multiple operational states of the apparatus depicted.

### DETAILED DESCRIPTION

Apparatus and methods for affixing a crown to a tooth are provided. Apparatus and methods for removing a crown from a tooth are provided.

Methods may include applying an adhesive to the crown. Methods may include applying an adhesive to the tooth. The adhesive may be applied to an outer surface of the tooth. The adhesive may be applied to enamel of the tooth. The tooth may be shaped and/or contoured before applying the adhesive or before positioning the crown on the tooth.

The adhesive may include a cement. The adhesive may include a polymer. The adhesive may include any suitable adhering agent. Any suitable adhering agent may include a thermoplastic. Any suitable adhering agent may include a ceramic.

The adhesive may be applied (to the tooth and/or crown) when the adhesive is in an inactive state. When the adhesive is in the inactive state, the adhesive may have a lower viscosity than after curing. When the adhesive is in the inactive state, the adhesive may be flowable. When the adhesive is in the inactive state, the adhesive may not bind the tooth to the crown. The adhesive may be positioned between the crown and the tooth. The adhesive may be cured and thereby securely affix the crown to the tooth. Curing the adhesive may include formation of chemical bonds. Curing the adhesive may include formation of a chemical structure. The chemical bonds may bind the tooth to the crown. The chemical structure may bind the tooth to the crown.

Curing the adhesive may include the formation of the chemical bonds within the adhesive. Curing the adhesive may include the formation of the chemical bonds within the adhesive between the crown and the tooth. Curing the adhesive may include the formation of the chemical bonds between the adhesive and the crown. Curing the adhesive may include the formation of the chemical bonds between the adhesive and the tooth.

The adhesive may be cured using a light source. Polymerization of the adhesive may be photo-catalyzed, with bond formation initiated by light. For example, the light source may illuminate the adhesive with ultraviolet wavelength light to cure the adhesive.

Methods may include positioning the crown over the tooth before curing the adhesive. The crown may be secured to the tooth using the adhesive. The adhesive may form an adhesive layer between the tooth and the crown. The adhesive layer when cured may securely affix the crown to the tooth.

Methods may include activating a “reflow” within the adhesive after the crown is securely affixed to the tooth by the cured adhesive. Reflow may lower the viscosity of the adhesive from its cured state. Reflowed adhesive may be flowable. The reflow may weaken the chemical structure of the cured adhesive securing the crown to the tooth. The reflow may weaken chemical bonds within the adhesive. The reflow may weaken chemical bonds securing the crown to the tooth. After activating the reflow, the crown may not be as securely affixed to the tooth as before the reflow was activated.

After activating the reflow and weakening the chemical bonds, the crown may be removed from the tooth using application of less mechanical force than would have been required had the chemical bonds securing the crown to the tooth not been weakened. Such application of less mechanical force may reduce the risk of damaging the tooth compared to attempts at removing the crown with the chemical bonds not having been weakened.

After activating the reflow, the crown may be removed from the tooth. The crown may be removed from the tooth by use of a pulling tool. The crown may be removed from the tooth by hand, without a pulling tool.

The reflow may be activated by applying non-mechanical energy to the adhesive. The non-mechanical energy may include heat energy. Applying heat may include raising a temperature of the adhesive any suitable number of degrees. For example, applying the heat may raise the temperature of the adhesive 7° C. above body temperature.

Applying the heat may include raising a temperature of the adhesive for any suitable period of time. The period of time may be a pre-determined period of time. For example, applying the heat may include raising the temperature of the adhesive 7° C. above body temperature for less than 5 seconds. Applying the heat may include raising the temperature of the adhesive 7° C. above body temperature for more than 5 seconds.

Applying the heat may be tuned to heat the adhesive within a pre-determined temperature range. For example, applying heat may raise the temperature of the adhesive between 7° C. and 8° C. above body temperature.

The adhesive may include ionic particles. The adhesive may include ceramic particles. The adhesive may include metal particles. The adhesive may include nano-particles. The metal particles may be nano-particles. For example, the adhesive may include a thermoplastic that is doped with metal particles.

Applying the heat to activate the reflow may cause the metal particles within the adhesive to expand. Expanding the metal particles after the adhesive has been cured may weaken the chemical bonds securing the crown to the tooth.

Methods may include activating the reflow by applying non-mechanical energy to the adhesive. The non-mechanical energy may include non-radiant energy. The non-mechanical energy can include sonic energy. The sonic energy can be in the form of ultrasonic waves focused on the adhesive. The non-mechanical energy can be inductive heating generated within the adhesive. The inductive heating can be generated by application of an electric field to the adhesive.

After applying the non-mechanical energy, the crown may be removed from the tooth using less mechanical force than would have been required without application of the non-mechanical energy. The mechanical force required to remove the dental crown from the tooth after the application of the non-mechanical energy may be less (e.g., of lower magnitude) than a greater mechanical force that would have been required to remove the dental crown from the tooth before the application of the non-mechanical energy.

In some embodiments, methods may include activating the reflow by moving a tool around a surface area of the crown. The tool may include an electronic tool. The surface area may be an outer surface of the crown. The surface area may be a surface area visible to a practitioner treating the patient. Moving the tool around the surface area of the crown may apply heat to different areas of the adhesive. Moving the tool around the surface area of the crown may apply ultrasonic waves to the different areas of the adhesive. Moving the tool around the surface area of the crown may focus the heat and/or the ultrasonic waves on the different areas of the adhesive. The adhesive may be positioned underneath the surface area. The adhesive may be positioned above the surface area. The adhesive may be positioned between the crown and the tooth.

Methods may include applying heat to the adhesive using a tool that applies induction generated heat.

Methods may include activating the reflow by applying an electric field to the adhesive. Applying the electric field may weaken chemical bonds securing the crown to the tooth. Applying the electric field may weaken chemical bonds in the adhesive by causing regions within the adhesive of ions or metal particles to expand, individually and/or away from each other. Applying the electric field may weaken chemical bonds in the adhesive by causing ions within the adhesive to migrate in response to application of the electric field. Migration of ions within the adhesive may change (expand or contract) a volume of the adhesive.

A system for securing a crown to a tooth is provided.

The system may include an adhesive. The adhesive may be any suitable adhesive. The adhesive may be configured, in operation, to form one or more chemical bonds. The adhesive may be applied to a substrate. The substrate may be a tooth. The substrate may be a crown. After applying the adhesive to the substrate, the crown may be positioned on the tooth. The one or more chemical bonds may securely affix the crown to the tooth.

A system for removing a crown securely affixed to the tooth is provided. The system may include the adhesive. The adhesive may be physiochemically tuned (e.g., formulated with a specific composition) to interact with other components of the system to facilitate crown removal. For example, the adhesive may be doped with particles that respond to energy input from other components of the system.

The system may include an electronic tool. The electronic tool may, in operation, apply heat to the adhesive. The electronic tool may apply the heat after the crown has been secured to the tooth. Applying heat to the adhesive may weaken one or more of the chemical bonds of the adhesive. The electronic tool may be tunable to weaken one or more of the chemical bonds of the adhesive.

The electronic tool may apply heat to the adhesive using an inductive heating element. The adhesive may be doped with metal. When the electronic tool applies heat to the adhesive, the metal may expand and thereby weaken one or more of the chemical bonds within the adhesive.

The electronic tool may apply heat that raises a temperature of the adhesive any suitable number of degrees. For example, applying the heat may raise a temperature of the adhesive 7° C. above body temperature. The electronic tool may apply heat that raises the temperature of the adhesive between 7° C. and 8° C. above body temperature.

The electronic tool may apply heat to the adhesive such that the temperature of the adhesive is raised by any suitable number of degrees for any suitable period of time. For example, the electronic tool may apply heat that raises the temperature of the adhesive 7° C. above body temperature for less than 5 seconds. The electronic tool may apply heat that raises the temperature of the adhesive 7° C. above body temperature for more than 5 seconds.

The electronic tool may apply heat to the adhesive such that, during the heating, the temperature of the adhesive is raised more than the temperature of the crown or of the tooth.

The electronic tool may apply heat to the adhesive such that the temperature of the adhesive is raised and the temperature of the crown and the tooth remain substantially constant.

Methods for removing a crown secured to a tooth are provided.

The methods may include applying a binding agent to an outer surface of the secured crown. The outer surface may include a “biting” surface of the crown. The outer surface may include a surface of the crown visible to a practitioner when treating the patient. The adhesive may be applied to any suitable outer surface of the crown.

The binding agent may include a glue. The binding agent may include a cement. The binding agent may include a polymer. The binding agent may include a thermoplastic. The binding agent may include an adhesive substantially similar to the adhesive used to securely affix the crown to the tooth. The binding agent may have none, some or all of the properties of the adhesive used to securely affix the crown to the tooth. The binding agent may be any suitable binding agent.

The methods may include, using the binding agent, coupling an agitator to the outer surface of the crown. The methods may include, using the agitator, applying a mechanical force to the crown. The force may vibrate the crown. The force may pull the crown.

For example, a root canal of a tooth may approximately define a longitudinal axis. The force applied by the agitator may apply a tensile force along the longitudinal axis. The agitator may apply the tensile force such that substantially all of the force is applied along the longitudinal axis.

The force may weaken one or more chemical bonds within the adhesive that secure the crown to the tooth. After applying the force to the crown, the methods may include removing the crown from the tooth. After applying the force, the crown may be removed from the tooth with less force than would have been required had the agitator not applied the force to the crown.

The force applied by the agitator to the crown may weaken chemical bonds securing the crown to the tooth. The force applied by the agitator may be an order of magnitude less than a force that would damage the tooth. The force applied by the agitator may be applied in a direction (such as along the longitudinal axis of the tooth) that reduces a likelihood of damage to the tooth when applying the force.

The methods may include curing the binding agent to couple the agitator to the outer surface of the crown. The binding agent may be cured after applying the binding agent to the outer surface of the crown and before applying the force. The curing of the binding agent may bind the agitator to the crown. The curing of the binding agent may trigger the formation of one or more than one chemical linkage(s) within the binding agent. The chemical linkage(s) may secure the agitator to the crown. The binding agent may be cured by any suitable methods such as applying radiant energy, a chemical solution, or heat to the adhesive.

The methods may include shaping the tooth before the crown is secured to the tooth. The tooth may be shaped such that when the force is later applied by the agitator (when attempting to remove the crown), the force is applied in a direction that corresponds to a direction of the weakest chemical bonds in the adhesive that secure the crown to the tooth.

For example, before applying a crown, a tooth may be shaped in a frustoconical, pyramidal or triangular shape. When force is later applied along a longitudinal axis of the tooth, the force may be applied to the weakest chemical bonds within the adhesive that secure the crown to the tooth. By applying force along the longitudinal axis of the tooth, the force may break or weaken the chemical bonds securing the crown to the tooth. Applying force to the weakest chemical bonds within the adhesive may reduce a quantity of force that is needed to loosen the crown and may, thereby, reduce a risk that the force may damage the tooth.

After breaking or weakening the chemical bonds securing the crown to the tooth, the crown may be easily removed from the tooth.

A system for removing a crown from a tooth is provided.

The system may include a crown. The crown may be secured to a tooth. The system may include a pulling tool. The pulling tool may be configured to be coupled to the crown. In some embodiments, the pulling tool may be configured to be releasably coupled to the crown. In some embodiments, the pulling tool may not be removed from the crown after being coupled to the crown.

In operation, when the pulling tool is coupled to the crown, the pulling tool may apply a mechanical force to the crown. The pulling tools may apply the force along a longitudinal axis of the tooth. The longitudinal axis may be defined by a root canal of the tooth. The force may agitate the crown. The force may be applied such that most of the force is applied along the longitudinal axis.

The pulling tool may be coupled to the crown by a binding agent. The binding agent used to couple the pulling tool and the crown may be substantially similar to the binding agent that may be used to couple the agitator to the crown. The binding agent may be any suitable binding agent.

The binding agent may be applied to one or more of the pulling tool and the crown. The pulling tool may include an adaptor for curing the binding agent. For example, the adaptor may apply ultraviolet light to cure the binding agent. The adaptor may apply ultrasonic waves to cure the binding agent. The adaptor may apply heat to cure the binding agent. Curing the binding agent may bind the pulling tool to the crown.

The pulling tool may include an electric motor. The pulling tool may include a semi-circular disk. The electric motor may rotate the semi-circular disk about an axis. Rotating the semi-circular disk may generate a vibratory force. When the pulling tool is coupled to the crown, the pulling tool may apply the vibratory force to the crown.

A system for removing a crown secured by an adhesive to a tooth is provided.

The system may include the adhesive. The adhesive may be physiochemically (compositionally) tuned to interact with other components of the system to facilitate removing the crown. The adhesive may be applied to a substrate. The adhesive may be applied to a device or appliance. The device or appliance may be positioned overlaying or underlying the substrate. The adhesive may be cured. The adhesive may form one or more chemical bonds. The one or more chemical bonds may bind the device or appliance to the substrate. For example, the device or appliance may be a crown and the substrate may be a tooth. The crown may be secured to the tooth by the one or more chemical bonds. The crown may be secured to the tooth via the one or more chemical bonds.

The system may include an electronic tool. The electronic tool may, in operation, apply an electric field to the adhesive. The adhesive may less securely affix the crown to the tooth after application of the electrical field than before the application of the electrical field. Applying the electric field to the adhesive may weaken one or more of the chemical bonds that bind the tooth to the crown. Weakening of the bond(s) may result in the adhesive less securely affixing the crown to the tooth after the application of the electrical field than before the application of the electrical field.

For example, different components of the adhesive or cement that secures the crown to the tooth may have different properties; e.g., a +ve (a positive coefficient of thermal expansion, as exhibited by most materials, such as metals) vs. a −ve (a negative coefficient of thermal expansion, as exhibited by, e.g., ceramics such as cubic zirconium tungstate). Applying the electric field to the adhesive may heat the adhesive. Heating the adhesive may cause deformation or “crunching” in the bond line that secures the crown to the tooth. Applying the electric field may provide instant and reliable failure of the adhesive that secures the crown to the tooth, allowing for easy removal of the crown.

The adhesive may be doped with particles of metal (typically, a +ve material). When the electronic tool applies the electric field, the metal within the adhesive may expand. The expansion of the metal may weaken one or more of the chemical bonds securing the tooth to the crown.

The adhesive may be doped with particles of a material with a negative coefficient of thermal expansion (a −ve material). When the electronic tool applies the electric field, the −ve material within the adhesive may contract. The contraction of the -ve material may weaken one or more of the chemical bonds securing the tooth to the crown.

The electronic tool may be configured to apply a time-varying electric field to the adhesive.

In some embodiments, applying the electric field may heat the adhesive. For example, applying the electric field may heat the adhesive such that the temperature of the adhesive is raised 7° C. above body temperature.

When the electronic tool applies the electric field to the adhesive, the temperature of the adhesive may be raised 7° C. above body temperature for less than 5 seconds.

When the electronic tool applies the electric field to the adhesive, the temperature of the adhesive may be raised more than the temperature of the crown or tooth. Raising the temperature of the adhesive more than the temperature of the tooth may reduce a risk of damaging the tooth when attempting to remove the crown from the tooth.

In some embodiments, the electronic tool may be tunable such that when the electronic tool applies the electric field to the adhesive, the temperature of the adhesive is raised and the temperature of the crown and the tooth remain substantially constant.

Methods for removing a crown secured to a tooth are provided.

The methods may include exposing adhesive that secures the crown to the tooth. The adhesive may be positioned between a contour of the crown and a contour of the tooth. The adhesive may be positioned between an inside contour of the crown and an outside contour of the tooth. The inside contour of the crown may be three-dimensionally complementary to the outside contour of the tooth. The adhesive may form an adhesive layer between the tooth and the crown. The adhesive may secure the crown to the tooth.

The adhesive may be exposed by drilling a hole in the crown. In some embodiments, an aperture may be pre-fabricated in the crown. The aperture may be filled with filler material. The aperture may be filled before the crown is secured to the tooth by the adhesive. The aperture may be filled after the crown is secured to the tooth by the adhesive.

When a practitioner desires to remove the crown (after the crown has been secured to the tooth), the filler material may be removed from the pre-fabricated hole. Removing the filler material may expose the adhesive that secures the crown to the tooth.

After exposing the adhesive, the methods may include introducing moisture into the adhesive. The adhesive may be physiochemically (compositionally) tuned such that the moisture can trigger a reaction within the adhesive. The reaction may weaken chemical bonds within the adhesive. The methods may include removing the crown after the reaction occurs.

In some embodiments, the methods may include freezing the moisture after introducing the moisture into the adhesive. The freezing may be accompanied by expansion of regions of water in the moisture. The freezing may weaken chemical bonds within the adhesive that secure the crown to the tooth.

The freezing may include exposing the crown to dry ice. The freezing may include spraying the crown with dry ice. Dry ice has low thermal mass and is less likely to damage surrounding tooth tissue.

Apparatus for a crown are provided. The crown may be secured and removed from a tooth. The crown may include a sealable aperture. The sealable aperture may be positioned in a side wall of the crown.

When the crown is positioned on the tooth, the sealable aperture may provide access to an adhesive that secures the crown to the tooth.

The crown may include a plug. The plug may seal the sealable aperture.

The sealable aperture may be tapped. The plug may include threads. The threads of the plug may be configured to engage the tapped sealable aperture. The plug may include a head. The plug may include an elongated body. The head may include one or more grooves. A driver may engage the one or more grooves. The driver may rotate the plug. Rotating the plug may loosen or tighten the plug within the sealable aperture.

In some embodiments, a re-curing of the adhesive may be carried out subsequent to reflow. For instance, a reflow caused by a thermal and/or chemical depolymerization of a polymer adhesive may be reversible under suitable thermal and/or chemical polymerization conditions, to yield a re-cured polymer adhesive.

Methods for removing a crown secured to a tooth are provided. The methods may include applying heat to an adhesive that secures the crown to the tooth. The methods may include at least partly melting the adhesive. The methods may include melting less than all of the adhesive between the tooth and the crown.

Melting the adhesive may weaken the chemical bonds that secure the crown to the tooth. After melting the adhesive, the methods may include mechanically removing the crown from the tooth. Mechanically removing the crown from the tooth may include mechanically sliding the crown off the tooth.

The adhesive may include any suitable adhesive. The adhesive may form an adhesive layer. The adhesive layer may include a polymer. The adhesive layer may include a thermoplastic. The adhesive layer may include an inductive agent. For example, the inductive agent may be carbon black.

The methods may include using ultrasound to focus the applying of the heat on the adhesive layer. The methods may include using ultrasound to melt the adhesive. The methods may include using sonic energy to melt or change the chemical structure of the adhesive. The melting or changing may weaken the chemical structure of the adhesive affixing the crown to the tooth.

The methods may include using a laser to apply the heat to the adhesive. The methods may include tuning the laser such that when using the laser to apply heat to the adhesive, the laser raises a temperature of the adhesive and does not substantially change a temperature of the crown or a temperature of the tooth.

Methods may include exposing the adhesive to liquid. The liquid may cause the adhesive to swell, thereby resulting in breaking or weakening of bonds within the adhesive that secure the crown to the tooth. The swelling of the adhesive in a space between the crown and the tooth may push the crown off the tooth.

For example, the adhesive may include a hydrogel. A hydrogel typically swells when exposed to specific liquids. The swelling of the hydrogel may result in breaking of bonds securing a crown to a tooth.

A system for removing a crown that is secured to a tooth is provided. The system may include a polymer adhesive. The system may include a crown secured to a tooth by the polymer adhesive.

The system may include an inductive heating element. The inductive heating element may be included in an electronic tool. The electronic tool may be configured to apply the inductive heating. The adhesive may be physiochemically (compositionally) tuned to be inductively heated. For example, the adhesive may include compositional elements exhibiting thermal responsiveness to applied energy and/or to an applied electric field. The adhesive may include components (such as particles of carbon black, or doped or undoped carbon nanotubes) that may be heated inductively.

The inductive heating element may be tunable to change a chemical structure of the polymer adhesive. The inductive heating element may be tuned to heat and at least partly melt the polymer adhesive. The inductive heating element may be tuned to change a chemical structure of the polymer adhesive. After a melting of the polymer adhesive, the crown may be removed from the tooth.

The inductive heating element may be tunable to heat the polymer adhesive above a threshold temperature. The inductive heating element may be tuned to heat the polymer adhesive above a threshold temperature.

The inductive heating element may be tunable to heat only the polymer adhesive above a threshold temperature. For example, the inductive heating element may be tuned such that when heat is applied to the polymer adhesive, the tooth remains below a threshold temperature. The inductive heating element may be tuned such that when heat is applied to the polymer adhesive, the crown preferably remains below a threshold temperature.

The system may include a sonic energy source. The sonic energy source may be included in an electronic tool. The electronic tool may be configured to generate sonic energy. The sonic energy source may be tunable to change a chemical structure of the polymer adhesive. The sonic energy source may be tunable to inductively heat the adhesive. The sonic energy source may be tunable to heat and at least partly melt the polymer adhesive. After a melting of the polymer adhesive, the crown may be removed from the tooth.

The sonic energy source may be tunable to heat the polymer adhesive above a threshold temperature. The sonic energy source may be tuned to heat the polymer adhesive above a threshold temperature.

The sonic energy source may be tunable to heat only the polymer adhesive above a threshold temperature. For example, the sonic energy source may be tuned such that when heat is applied to the polymer adhesive, the tooth remains below a threshold temperature. The sonic energy source may be tuned such that when heat is applied to the polymer adhesive, the crown preferably remains below a threshold temperature. The sonic energy source may be tuned (e.g., to a specific frequency range (Hz)) such that when heat is applied to the polymer adhesive, the tooth preferably remains below a threshold temperature.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

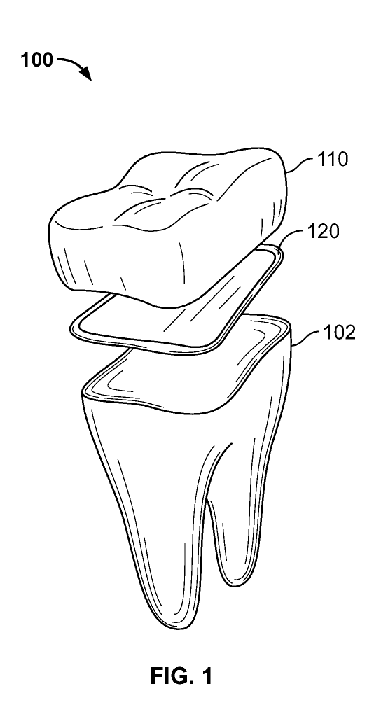

FIG. 1 shows an illustrative exploded view of apparatus 100. Apparatus 100 includes tooth 102, crown 110, and adhesive layer 120. Adhesive layer 120 may be include a polymer adhesive. Adhesive layer 120 may include an inductive agent. Adhesive layer 120 may include a cement. Adhesive layer 120 may be used to secure crown 110 to tooth 102.

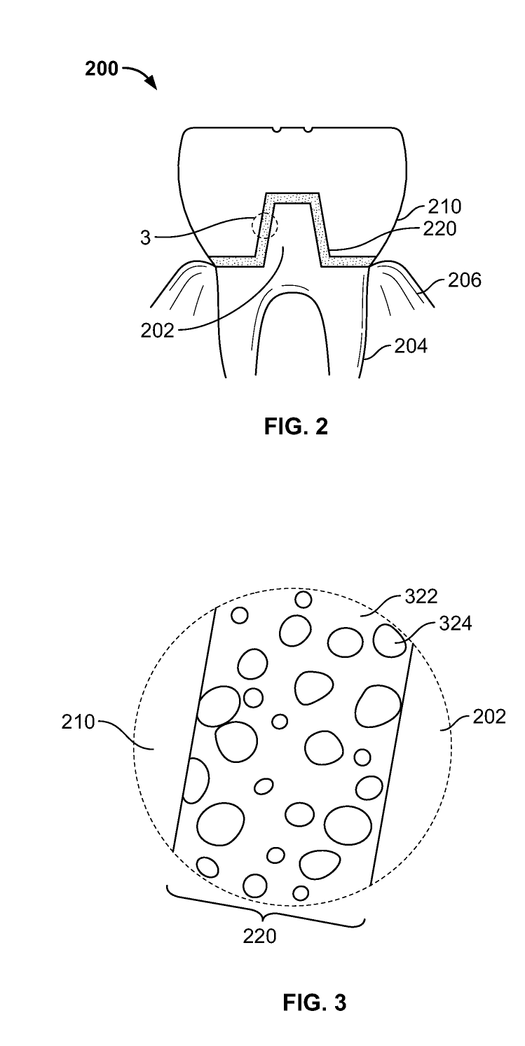

FIG. 2 shows apparatus 200 in partial cross-section. Apparatus 200 includes tooth 202, root 204 and surrounding tissue 206. Apparatus 200 includes crown 210 and adhesive layer 220. FIG. 2 shows tooth 202 shaped with external contours complementary to internal contours of crown 210. Adhesive layer 220, positioned between tooth 202 and crown 210, may be used to secure crown 210 to tooth 202. Chemical bonds (not shown) within adhesive 220, between adhesive 220 and tooth 202, and/or between adhesive 220 and crown 210 may securely affix crown 210 to tooth 202. (FIG. 2 features a detail section labeled 3, shown in expanded view in FIG. 3.)

FIG. 3 shows that adhesive 220 may include multiple components. Adhesive 220 may include adhesive medium 322. Medium 322 may include a polymer, a cement or any suitable adhesive medium. Adhesive 220 may include particles 324 within medium 322. Particles 324 may include metal. Particles 324 may include ions. Particles 324 may include carbon black. Particles 324 may include carbon nanotubes. Particles 324 may be include ceramic particles. Adhesive 220 may simultaneously include several different types of particles 324, such as metal particles and ceramic particles. Particles 324 may be distributed homogeneously or heterogeneously throughout medium 322.

Properties of adhesive 220 can be tuned by formulation of adhesive 220 with specific amounts of one type or several diverse types of particles 324. The response of adhesive 220 to electric fields, sonic waves and/or heating may be tuned by judicious selection of medium 322 and particles 324. Medium 322 may warm, and become less viscous, in response to sonic waves and/or heating. Particles 324 such as metals typically exhibit positive coefficients of thermal expansion; regions within adhesive 220 containing such particles may expand upon heating. Particles 324 such as unique ceramics (e.g., cubic zirconium tungstate, ZrW₂O₈) exhibit negative coefficients of thermal expansion; regions within adhesive 220 containing such particles may contract upon heating. Particles 324 such as carbon black or carbon nanotubes may serve as compositional elements with thermal responsiveness to radiant energy, sonic energy, non-mechanical energy, mechanical energy and/or to an electric field. Particles 324 such as carbon black or carbon nanotubes may serve as adhesive-based induction heating elements. Particles 324 that are ionic may migrate and/or exert forces (in a direction of migration) within medium 322 in the presence of an electrical field. When regions within adhesive 220 expand, contract and/or experience directional forces, chemical bonds (not shown) securing crown 210 to tooth 202 may weaken and/or break in, and/or adjacent to, those regions. Weakened and/or broken bonds in adhesive 220 may activate reflow of adhesive 220. Thus, judicious formulation of adhesive 220 may yield a cured adhesive securely affixing crown 210 to tooth 202 but that can be reflowed under particular conditions to facilitate removal of the crown from the tooth.

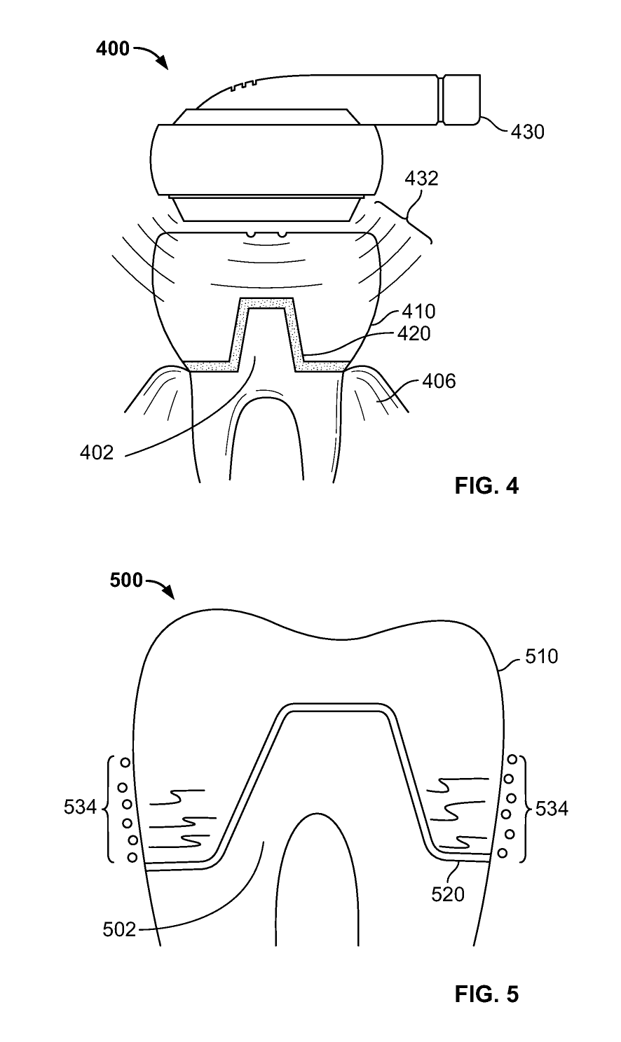

FIG. 4 shows illustrative therapeutic scenario 400. Scenario 400 shows electronic tool 430. Scenario 400 shows adhesive 420 between crown 410 and tooth 402.

Electronic tool 430 may be tunable to activate reflow within adhesive 420. Electronic tool 430 may activate the reflow by transmitting energy 432 to adhesive 420. Energy 432 may be non-mechanical energy. Energy 432 may be sonic energy. Energy 432 may be heat energy. For example, electronic tool 430 may activate the reflow by heating adhesive 420. By activating the reflow within adhesive 420, chemical bonds securing crown 410 to tooth 402 may be weakened. Weakening the chemical bonds securing crown 410 to tooth 402 (by application of energy 432) may facilitate subsequent removal of crown 410 from tooth 402 with minimal impact on the integrity of tooth 402 or of surrounding tissue 406.

FIG. 5 shows illustrative therapeutic scenario 500. Scenario 500 shows adhesive 520 between tooth 502 and crown 510. Adhesive 520 may secure crown 510 to tooth 502. An electronic tool, such as tool 430 (shown in FIG. 4) may, in operation, apply electric field 534 to adhesive 520.

Applying electric field 534 to adhesive 520 may weaken chemical bonds within adhesive 520 that secure crown 510 to tooth 502.

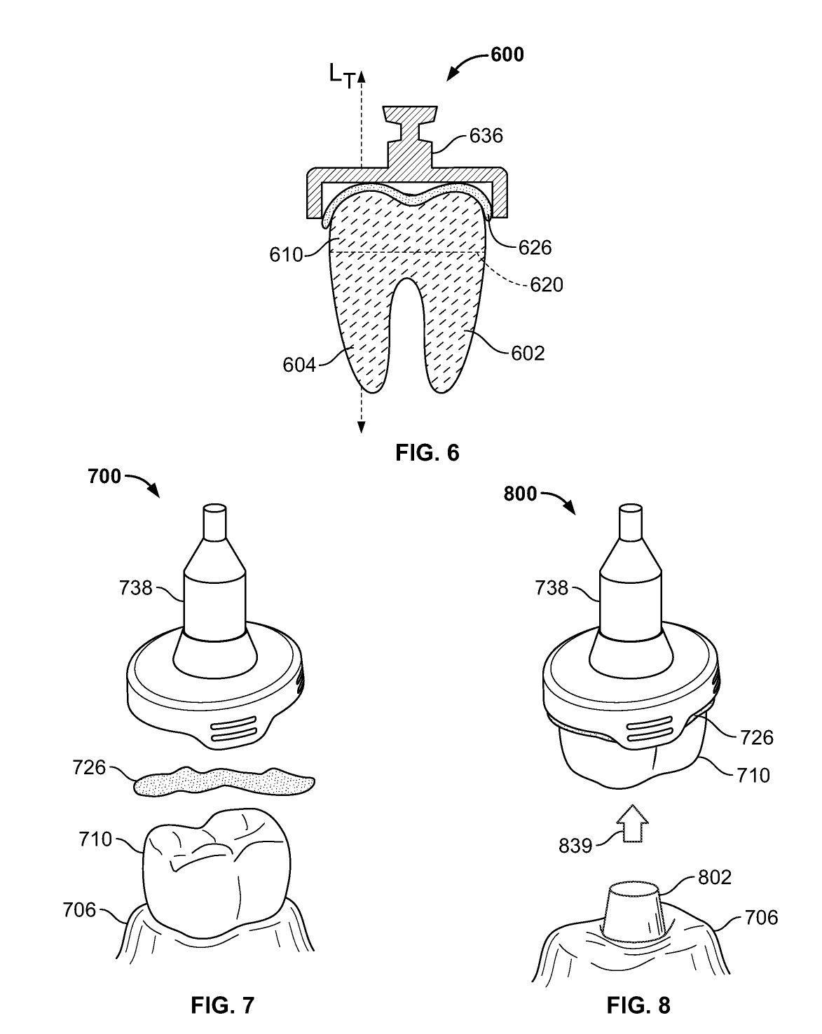

FIG. 6 shows illustrative therapeutic scenario 600. Scenario 600 shows pulling tool 636. Crown 610 may be secured to tooth 602. Crown 610 may be secured to tooth 602 by adhesive 620 (shown in phantom between tooth 602 and crown 610). Root 604 of tooth 602 may define longitudinal axis L_{T}.

Binding agent 626 may be used to secure pulling tool 636 to crown 610. Binding agent 626 may be similar in one or more properties to adhesive 620 securely affixing crown 610 to tooth 602. Binding agent 626 may have properties different from adhesive 620.

Pulling tool 636 may apply mechanical force to crown 610. The force may remove crown 610 from tooth 602. Pulling tool 636 may be configured to apply a force that is substantially aligned along (parallel to) axis L_{T}. A force applied substantially along axis L_{T} may correspond to applying a force to the weakest chemical bonds (not shown) within adhesive 620. Such bonds may have been weakened by reflow within adhesive 620. A force applied substantially along axis L_{T} may have minimal impact on tooth 602 and on surrounding tissue (not shown). Such force may be applied following activation of reflow in adhesive 620.

In some embodiments, pulling tool 636, when secured to crown 610, may be configured to vibrate (agitate) crown 610. Vibrating crown 610 may weaken and/or break chemical bonds (not shown) within adhesive 620. Pulling tool 636 may be used to vibrate crown 610 before and/or after activation of reflow of adhesive 620.

FIG. 7 shows illustrative apparatus 700. Apparatus 700 includes pulling tool 738. Pulling tool 738 may include one or more features of pulling tool 636 (shown in FIG. 6). Apparatus 700 includes binding agent 726. Binding agent 726 may be applied to crown 710 and/or pulling tool 738. Crown 710 may be positioned over and secured to a tooth (not shown) seated in tissue 706. Binding agent 726 may be used to bind crown 710 to pulling tool 738.

Pulling tool 738 may include or be associated with an agent curing module (not shown). The agent curing module may initiate and/or accelerate curing of binding agent 726. The agent curing module may initiate and/or accelerate binding of pulling tool 738 to crown 710. The agent curing module may include a heat source (not shown) for heating binding agent 726. The agent curing module may include a chemical solution (not shown) for catalyzing or otherwise accelerating a curing process in binding agent 726. The agent curing module may include a radiant energy source (not shown) for photo-catalyzing the curing process in binding agent 726.

Pulling tool 738 may include or be associated with a motor (not shown) for generating a vibratory force. When pulling tool 738 is bound to crown 710, pulling tool 738 may apply the vibratory force to crown 710.

When pulling tool 738 is bound to crown 710, pulling tool 738 may apply a force to crown 710. Pulling tool 738 may apply a force that breaks and/or weakens chemical bonds within an adhesive (not shown) that secures crown 710 to the tooth (not shown) seated in tissue 706. Pulling tool 738 may apply a force that does not disturb a position of the tooth relative to tissue 706.

FIG. 8 shows illustrative therapeutic scenario 800. Scenario 800 shows pulling tool 738 applying force 839 to crown 710. Scenario 800 shows pulling tool 738 applying force 839 to crown 710 along (parallel to) a longitudinal axis (not shown; similar to axis L_{T} shown in FIG. 6) of tooth 802. The longitudinal axis may be defined by a root (not shown) of tooth 802. In some embodiments, a force applied by pulling tool 738 may include components that are not aligned along the longitudinal axis of tooth 802.

Scenario 800 shows that pulling tool 738 may apply force 839 to crown 710 and remove crown 710 from tooth 802. Force 839 applied by pulling tool 738 may break and/or weaken bonds within an adhesive (not shown) disposed between crown 710 and tooth 802 before removal of crown 710 from tooth 802.

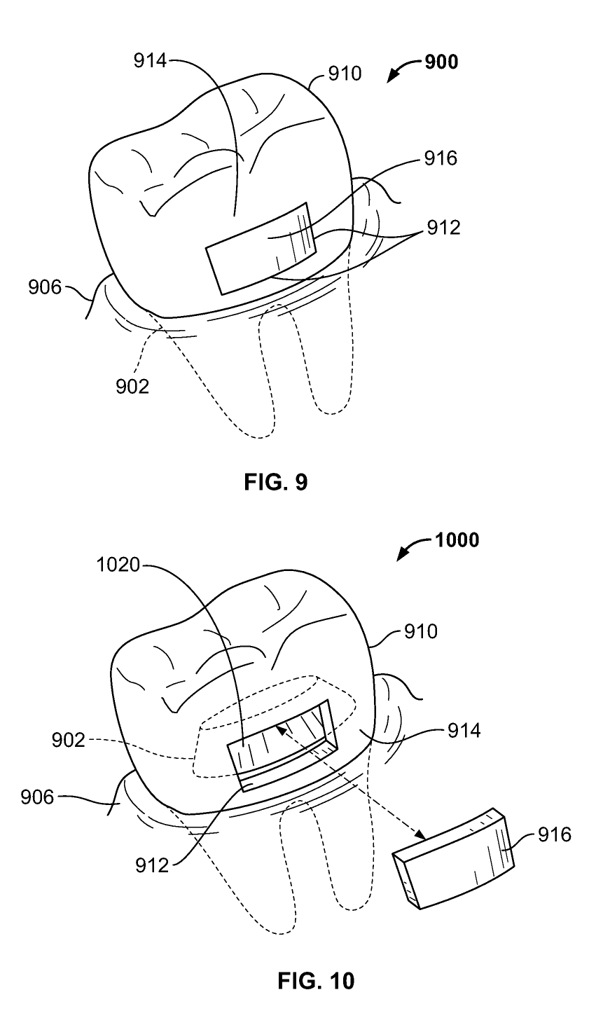

FIG. 9 shows illustrative apparatus 900. Apparatus 900 includes crown 910. Crown 910 may be secured to tooth 902 (shown in phantom) set in surrounding tissue 906. Crown 910 may be secured to tooth 902 by an adhesive (not shown) between crown 910 and tooth 902. FIG. 9 shows the edges of aperture 912 in side wall 914 of crown 910. FIG. 9 shows plug 916 disposed within aperture 912. Aperture 912 may provide access, through side wall 914, to the adhesive that secures crown 910 to tooth 902. The aperture represented by illustrative aperture 912 may have any suitable shape (such as an open circle); the plug represented by illustrative plug 916, may have any suitable shape (such as that of a disk to complement and fill a circular aperture).

Via aperture 912, the adhesive (not shown) that secures crown 910 to tooth 902 may be exposed to moisture or other chemical agents. Exposing the adhesive to moisture or other chemical agent(s) may include injecting moisture or other chemical agent(s) onto and/or into the adhesive via aperture 912. Exposure of the adhesive to moisture or other chemical agent(s) may trigger a reaction within the adhesive that secures crown 910 to tooth 902. The reaction may break and/or weaken bonds (not shown) within the adhesive that secures crown 910 to tooth 902.

In some embodiments, dry ice or other cooling agent(s) may be applied after exposing the adhesive to moisture. The dry ice or other cooling agent(s) may cause the moisture to freeze and expand, thereby breaking and/or weakening bonds (not shown) within the adhesive that secures crown 910 to tooth 902.

FIG. 10 shows illustrative apparatus 1000. In apparatus 1000, aperture 912 in side wall 914 is depicted unoccupied by plug 916. FIG. 10 shows that plug 916 may be removed from and/or reinserted into aperture 912. Plug 916 may be used to fill and/or seal aperture 912. Removal of plug 916 from aperture 912 may unseal aperture 912.

For example, plug 916 may be removed from aperture 912 if and when it is desirable to remove crown 910 from tooth 902 (shown in phantom). Removing plug 916 may expose at least part of adhesive 1020 that secures crown 910 to tooth 902, and allow moisture and/or other chemical/cooling agent(s) to be inserted onto and/or into adhesive 1020. As presented above in description of FIG. 9, exposure of adhesive 1020 to moisture and/or other chemical/cooling agent(s) may break and/or weaken bonds (not shown) securing crown 920 to tooth 902.

Breaking and/or weakening bonds in adhesive 1020 may facilitate removal of crown 910 from tooth 902 with minimal risk of damage to tooth 902 or to tissue 906.

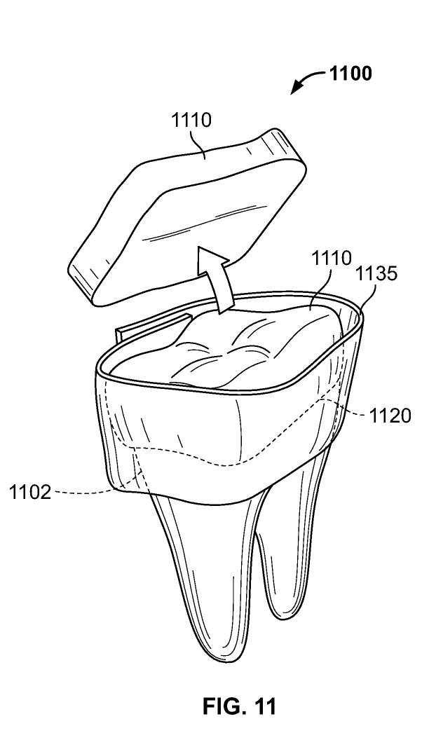

FIG. 11 shows illustrative therapeutic scenario 1100. Scenario 1100 shows heating element 1135 wrapped around crown 1110 and tooth 1102 (shown in phantom). In scenario 1100, heating element 1135 is depicted as applying heat to adhesive layer 1120 (shown in phantom) between crown 1110 and tooth 1102. Heat applied to adhesive layer 1120 may melt adhesive layer 1120. Heat applied to adhesive layer 1120 may cause expansion and/or contraction of particles (not shown) within adhesive 1120. Heat applied to adhesive layer 1120 may break and/or weaken chemical bonds (not shown) of adhesive 1120 securely affixing crown 1110 to tooth 1102. Scenario 1100 shows that after sufficient heating of adhesive layer 1120, crown 1110 may be separable from tooth 1102.

Thus apparatus and methods for reversibly cementing (affixing) a crown to a tooth have been provided. Persons skilled in the art will appreciate that the present invention can be practiced by other than the described embodiments, which are presented for purposes of illustration rather than of limitation. The present invention is limited only by the claims that follow.

What is claimed is:

1. A system for removal of a dental crown securely affixed to a tooth, the system comprising:
an adhesive that:
is curable to form one or more chemical bonds, the adhesive positioned between the dental crown and the tooth; and
affixes the dental crown to the tooth by the one or more chemical bonds; and
an electronic tool that in operation applies sonic energy to the adhesive and weakens the one or more chemical bonds of the adhesive such that the adhesive less securely affixes the dental crown to the tooth after application of the sonic energy than before the application of the sonic energy.

2. The system of claim 1 wherein the electronic tool applies the sonic energy in the form of ultrasonic waves.

3. The system of claim 1 wherein the electronic tool, in operation:
is movable around an outer surface area of the dental crown; and,
when moved, focuses the sonic energy on different areas of the adhesive.

4. The system of claim 1 wherein the electronic tool is tunable such that when in operation the tool applies the sonic energy to the adhesive, the sonic energy heats the adhesive.

5. The system of claim 4 wherein the electronic tool is tunable to heat the adhesive to a higher temperature than the dental crown or the tooth.

6. The system of claim 4 wherein:
the adhesive includes particles that expand upon heating, the particles having a positive coefficient of thermal expansion; and
when the tool applies the sonic energy, the sonic energy triggers expansion of the particles and weakens the one or more chemical bonds of the adhesive.

7. The system of claim 4 wherein:
the adhesive includes particles that contract upon heating, the particles having a negative coefficient of thermal expansion; and
when the tool applies the sonic energy, the sonic energy triggers contraction of the particles and weakens the one or more chemical bonds of the adhesive.

8. The system of claim 4 wherein the electronic tool is tunable to heat the adhesive within a pre-determined temperature range.

9. The system of claim 8 wherein the pre-determined temperature range is between about 7° C. and about 8° C. above body temperature.

10. The system of claim 4 wherein the electronic tool is tunable to heat the adhesive for a pre-determined period of time.

11. The system of claim 10 wherein the pre-determined period of time is about 5 seconds.

12. A system for removing a dental crown securely affixed to a tooth, the system comprising:
an adhesive that in operation:
cures to form one or more chemical bonds, the adhesive positioned between the dental crown and the tooth; and
affixes the dental crown to the tooth by the one or more chemical bonds; and
an electronic tool that in operation applies an electrical field to the adhesive and the electrical field weakens the one or more chemical bonds of the adhesive such that the adhesive less securely affixes the dental crown to the tooth after application of the electrical field than before the application of the electrical field.

13. The system of claim 12 wherein the electric field is a time-varying electric field.

14. The system of claim 12 wherein the electronic tool is tunable to weaken the one or more chemical bonds by causing ions in the adhesive to migrate within the adhesive and weakening the one or more chemical bonds.

15. The system of claim 12 wherein the electronic tool is tunable to inductively heat the adhesive.

16. The system of claim 15 wherein the adhesive includes an inductive agent that undergoes heating in response to application of the electric field.

17. The system of claim 16 wherein the inductive agent is carbon black.

18. The system of claim 12 wherein, after application of the electric field, the dental crown is removable by hand, without a pulling tool.

19. A method of removing a dental crown securely affixed to a tooth, the dental crown secured via a chemical structure of a cured adhesive layer between the dental crown and the tooth, the method comprising:
applying non-mechanical energy to the adhesive layer;
in response to application of the non-mechanical energy, activating reflow within the adhesive layer and thereby weakening the chemical structure within the adhesive layer that secures the dental crown to the tooth, such that the dental crown is less securely affixed to the tooth after the activating than before the application of the non-mechanical energy; and
applying a first mechanical force to the dental crown to remove the dental crown from the tooth, the first mechanical force being less than a second mechanical force that would have been required to remove the dental crown from the tooth without the application of the non-mechanical energy.

20. The method of claim 19 wherein:
the non-mechanical energy is inductive heating generated by applying an electric field to the adhesive layer; and
the adhesive layer includes an inductive agent that undergoes heating in response to the electric field.

21. The method of claim 19 wherein the non-mechanical energy is sonic energy of ultrasound focused on the adhesive layer.
